(19) United States
(12) Patent Application Publication
(10) Pub. No.: US 2026/0057853 A1
(43) Pub. Date: Feb. 26, 2026

(54) OPTIMIZING RESPONSE TIME COMPENSATION PARAMETERS FOR DISPLAY PANELS

(71) Applicant: NVIDIA Corporation, Santa Clara, CA (US)

(72) Inventors: Rouslan Lyubomirov Dimitrov, Newark, CA (US); Gerrit Ary Slavenburg, Hayward, CA (US)

(21) Appl. No.: 18/756,996

(22) Filed: Jun. 27, 2024

Related U.S. Application Data
(60) Provisional application No. 63/524,617, filed on Jun. 30, 2023.

(51) Int. Cl. G09G 3/36; G09G 3/20

(52) U.S. Cl. CPC G09G 3/3607; G09G 3/2096; G09G 2320/0252; G09G 2320/0257; G09G 2320/0285; G09G 2320/0295; G09G 2360/142; G09G 2360/16

(57) ABSTRACT

In various examples, optimal response time compensation (RTC) parameters may be determined for a display panel—such as a liquid crystal display (LCD) panel—based on sensor data. For instance, the disclosed systems and methods may calibrate optimal RTC parameters by using one or more sensors to generate sensor data while causing a display to render one or more images. The sensor data may be indicative of luminance values associated with at least one pixel of the display during a transition of the pixel from a first color value to a second color value. Using the sensor data, an optimal level of an overdrive voltage/RGB value may be determined for transitioning the pixel from the first color value to the second color value. Additionally, in some instances the overdrive may be determined in perceptual space by mapping the luminance values to perceptual brightness values.

### CROSS-REFERENCE TO RELATED APPLICATIONS

This application claims the benefit of U.S. Provisional Application No. 63/524,617, filed on Jun. 30, 2023, which is incorporated herein by reference in its entirety and for all purposes.

### BACKGROUND

Modern display panels—such as Liquid Crystal Display (LCD) panels—may moderate light flow and produce images by rotating liquid crystal molecules to various alignments that transmit different levels of light/color, depending on the electrical setting at each individual pixel of the display. While effective for creating high-quality visuals, the speed at which these liquid crystal molecules rotate is relatively slow, typically below the image refresh rate of the display panel. Thus, due to the nature of liquid crystal technology, LCD displays may have inherent limitations affecting how quickly the pixels can change states. As a result, in certain scenarios, such as when a scene is changing fast or a fast-moving image is being displayed, the slow transition of pixels can lead to motion blur, ghosting effects, and/or even objects disappearing from an image entirely.

Various techniques for accelerating the pixel transition process and compensating for LCD response time have been developed. For instance, overdrive techniques attempt to compensate for the disparity between the rotation speed and the image refresh rate by sending a higher initial voltage instead of the typical expected voltage to each pixel, and subsequently moderating that voltage as it approaches the desired performance level. However, deriving the configuration and/or settings can be an inefficient and labor-intensive process, often requiring significant trial and error, and/or can result in sub-optimal derivations. For instance, because determining overdrive settings is conventionally a manual process, hundreds—or even thousands—of labor-hours can be spent to tune a display panel. Additionally, due to factors such as fluctuations in design and component quality and operation, each panel model—and sometimes even each individual display panel—may require its own configuration and/or settings to reach a desired level of performance.

### SUMMARY

Embodiments of the present disclosure relate to optimizing response time compensation (RTC) parameters for display panels. Systems and methods are disclosed that, among other things, may determine optimal RTC parameters for display panels—such as liquid crystal display (LCD) panels or any other types of display panels—based on sensor data.

In at least one example, the disclosed systems and methods may calibrate optimal RTC parameters by using one or more sensors to generate sensor data while causing a display to render one or more images. The sensor data may be indicative of luminance values associated with at least one pixel of the display during a transition of the pixel from a first color value to a second color value during the rendering of the one or more images. Using the sensor data, an optimal level of an overdrive voltage/RGB value may be determined for transitioning the pixel from the first color value to the second color value. Additionally, in some instances the overdrive voltage levels/RGB values may be determined in perceptual space by mapping the luminance values to perceived brightness values using one or more functions.

In contrast to conventional systems, such as those described above, the systems of the present disclosure, in some embodiments, are able to determine optimal overdrive voltage levels and/or any other RTC parameters for display panels by tuning the display panels using sensor data. As described in more detail herein, by tuning display panels using sensor data, the systems of the present disclosure may determine more optimal overdrive voltage levels for display panels over a wider spectrum of pixel values, thereby enhancing the performance of display panels by, among other things, improving pixel response time, reducing motion blur associated with fast-moving images, improving clarity by reducing ghosting, etc. Additionally, in contrast to the conventional systems, the current systems, in some embodiments, are able to tune RTC parameters in linear space and/or in perceptual space. For instance, by mapping sensor-measured luminance values to brightness values in perceptual space, the current systems are able to use automated and computer-implemented methods to effectively—and more efficiently—tune displays to render images that appear more optimal to end users than conventional, manual methods.

### BRIEF DESCRIPTION OF THE DRAWINGS

The present systems and methods for optimizing response time compensation (RTC) parameters for display panels are described in detail below with reference to the attached drawing figures, wherein:

FIG. 1 is a data flow diagram illustrating an example process for determining RTC parameters associated with a display, in accordance with some embodiments of the present disclosure;

FIGS. 2A and 2B illustrate example visualizations of images that a system may cause a display to render for determining RTC parameters, in accordance with some embodiments of the present disclosure;

FIG. 2C illustrates an example visualization of an applied voltage associated with rendering a series of images, in accordance with some embodiments of the present disclosure;

FIG. 3 illustrates an example visualization of a relationship between luminance of a display panel and voltage applied to the display panel, in accordance with some embodiments of the present disclosure;

FIG. 4 illustrates an example function curve that may be used to map luminance values to perceived brightness values, in accordance with some embodiments of the present disclosure;

FIG. 5 illustrates an example lookup table that may be generated in accordance with some embodiments of the present disclosure;

FIG. 6 illustrates an example system that may be used to determine RTC parameters associated with a display, in accordance with some embodiments of the present disclosure;

FIG. 7 is a flow diagram illustrating an example method for tuning overdrive values for a display panel based on sensor data, in accordance with some embodiments of the present disclosure;

FIG. 8 is a flow diagram illustrating an example method for tuning overdrive values for a display panel in perceptual space, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to optimizing response time compensation (RTC) parameters for display panels. For instance, a system(s) may cause a display (also referred to herein as a “display panel”) to render a series of images. While the display is rendering the series of images, the system(s) may obtain sensor data indicating luminance values associated with at least one pixel of the display during a transition of the pixel from a first value (e.g., initial value) to a second value (e.g., ending value). The system(s) may use the luminance values to determine an overdrive voltage (also referred to herein as an “RGB offset” or “overdrive RGB value”) to apply to the pixel of the display to transition the pixel from the first value to the second value through an intermediate value (e.g., overdrive value). The system(s) may also store the overdrive voltage/RGB offset in an overdrive table that is stored in a memory and/or firmware of the display.

As described herein, the system(s) may perform the disclosed techniques using a variety of different types of displays. For instance, the type of the display may include, but is not limited to, an LCD display, a plasma display, a digital light processing (DLP) display, a Liquid Crystal on Silicon (LCoS) display, or any other types of displays. In some examples, the system(s) may include one or more applications executing on a computing device, and to cause the display to render the series of images, the system(s) may use the application(s) to send image data representing the series of images to a graphics processing unit (GPU) of the computing device. The GPU may process the image data and send it to the display (e.g., to a display controller of the display), and the display may render the series of images corresponding to the image data.

In various examples, the series of images rendered on the display may correspond to a pattern and/or series of patterns to cause pixels of the display to transition between various values. For instance, a first image of the series of images may correspond to a first portion of the pattern, a second image of the series of images may correspond to a second portion of the pattern, and so forth. To render the first image, the display may apply a first voltage level (e.g., RGB level) to the pixels to set the pixels to one or more initial values. Similarly, to render the second image, the display may transition the pixels from the initial values to one or more target values by applying a second voltage level (e.g., RGB level) to the pixels. As described herein, during the transition of the pixels from the initial values to the target values, the system(s) may apply an overdrive voltage to the pixels to accelerate the transition from the initial values to the target values. The overdrive voltage may differ in magnitude from the second voltage level. For instance, if the initial pixel values are less than the target pixel values, the overdrive voltage may be greater than the second voltage level. In contrast, if the initial values are greater than the target values, the overdrive voltage may be less than the second voltage level. As described herein, the values of the pixels—such as the initial values, the target values, intermediate values, or any other values—may correspond to colors and/or gray levels of the pixels, RGB values of the pixels, intensities of the pixels, voltage levels applied to the pixels, etc.

In some instances, the system(s) may cause the display to render the images of the series of images at one or more frame refresh rates. For example, the system(s) may cause the display to render the series of images at a first refresh rate (e.g., 120 Hz) to determine one or more first overdrive voltages to be applied to the pixels to transition between the initial values and the target values when the display is rendering images at the first refresh rate. Additionally, or alternatively, the system(s) may cause the display to render the series of images at a second refresh rate (e.g., 240 Hz) to determine one or more second overdrive voltages to be applied to the pixels to transition between the initial values and the target values when the display is rendering images at the second refresh rate. For instance, the display may be a variable refresh rate (VRR) display panel that dynamically adjusts the refresh rate to match the frame rate output of the content being rendered by the graphics card or video source, and the VRR display panel may use multiple overdrive tables and/or other RTC parameters for the different refresh rates.

As described herein, the system(s) may obtain sensor data associated with the display while causing the display to render the series of images. For instance, the system(s) may use one or more sensors to generate the sensor data while the display is rendering the series of images. That is, the system(s) may, in some instances, use the sensor(s) to measure the luminance of the screen of the display over time and convert the measured luminance to a digital representation. In some examples, the sensor data may indicate luminance values associated with the pixels of the display during the rendering of the images. Because the sensor data may be obtained while the display is rendering the series of images, the luminance values may be indicative of the actual or measured luminance of the pixels over time during the transition of the pixels from the initial values to the target values. In some instances, the sensor(s) may include, but are not limited to, photodiodes, photometers, spectroradiometers, lux meters (illuminance meters), colorimeters, a combination thereof, and/or any other sensors for measuring the luminance output by a display and/or pixels of a display. As such, the sensor data may include, but is not limited to, luminance data, color data, photodiode data, photometer data, spectroradiometer data, lux meter data, colorimeter data, a combination thereof, and/or any other sensor data for indicating luminance. In some examples, the sensor(s) may sample and/or measure the luminance of the display at various rates (e.g., 4096 Hz). The sensor(s) may connect to and/or interface with a computing device of the system(s) (e.g., via a USB or other connection). In some examples, the sensor(s) may detachably couple to the display proximate to the screen of the display. That is, the sensor(s) may contact or overlay the screen of the display panel.

Using the sensor data, the system(s) may determine various luminance measurements for the pixels that correspond to various values (e.g., gray level values, RGB values, etc.) of the pixels throughout the series of images. For instance, and for a transition of a pixel from an initial value to a target value, the system(s) may use the sensor data to determine a first luminance value corresponding to the initial value of the pixel, a second luminance value corresponding to the target value of the pixel, and a third luminance value corresponding to an overdrive voltage level applied to the pixel during the transition between the initial value and the target value. In some instances, the third luminance value corresponding to the overdrive voltage level may be representative of a maximum (e.g., peak) measured luminance between the first and second luminance values. Additionally, or alternatively, the third luminance value may be representative of the maximum luminance between the first and second luminance values at a certain point in time (e.g., at 5% of the duration of the frame). Additionally, the system(s) may determine luminance measurements for one or more intermediate points throughout the transition (e.g., at 10% and 90% through the transition, etc.) to determine a response time associated with the transition.

In some examples, the system(s) may use the various luminance values to determine or otherwise tune the overdrive voltage levels for the display. For instance, based on the first, the second, and the third luminance values described in the preceding paragraph, (e.g., the luminance at the pixel's initial value, the pixel's target value, and the overdrive, respectively), the system(s) may determine or otherwise refine the overdrive voltage level for the display. As a first example, if the initial pixel value is 100 RGB (e.g., 100, 100, 100), the target pixel value is 200 RGB, and the desired overdrive is 10% in perceived brightness or in measured luminance, the system(s) may iteratively update the overdrive voltage level, cause the display to render the images, and evaluate the third luminance value until an overdrive voltage level is determined that results in the third luminance value having a perceived brightness or a measured luminance that is 10% greater than the difference in perceived brightness or measured luminance between 100 RGB and 200 RGB.

In some examples, the system(s) may optimize this process when determining the overdrive voltage (e.g., RGB offset) for a specific transition of pixel values by adjusting the overdrive voltage in larger increments initially, and then making smaller adjustments as the overdrive voltage approaches the target. Continuing the example from above where the initial pixel value is 100 RGB, the target pixel value is 200 RGB, and the desired overdrive pixel value is 210 RGB, in a first iteration, the system(s) may initially set the overdrive voltage to 4.46 volts, which could be the standard voltage level applied to the pixel for it to output 210 RGB. After evaluating the sensor data, if the third luminance value corresponds to, for instance, an overdrive value of 202 RGB, the system(s) may determine to increase the overdrive voltage. In a second iteration, the system(s) may increase the overdrive voltage to 4.52 volts—which could be the standard voltage level to output 230 RGB—and then cause the display to render the images again using the updated parameters. After evaluating the sensor data (e.g., in a waveform or digital representation) from the second iteration, if the third luminance value corresponds to, for instance, an overdrive value of 214 RGB, the system(s) may determine to decrease the overdrive voltage, but by less of a magnitude than in the second iteration. For instance, in a third iteration, the system(s) may decrease the overdrive voltage to 4.50 volts and re-evaluate. This process may repeat, taking smaller and smaller voltage steps, until the system(s) determines the desired overdrive voltage for the transition from 100 RGB to 200 RGB for the display.

Additionally, in some examples, the system(s) may perform similar or the same techniques to determine the overdrive voltages for different refresh rates of the display. For instance, in some cases the display may be a variable refresh rate display, and to tune the overdrives for variable refresh rate displays the system(s) may vary the frame time (e.g., how long each image is presented on the screen) during tuning. That is, because the system(s) may be used to tune variable refresh rate displays as well as fixed refresh rate displays, the system(s) may be configured to tune overdrives for all rates associated with a given variable refresh rate display. For example, the GPUs of the system(s) may be configured to present a frame(s) to a display for a very precise and specific duration, which is generally not possible in conventional systems.

In some instances, the system(s) may determine the overdrive voltages for the display in perceptual space. That is, because the human eye perceives changes in light non-linearly, the system(s) may convert linear pixel values and/or luminance values to perceptual brightness values during tuning, which may allow the system(s) to tune the overdrive voltages in perceptual space and make the display output higher quality images than just tuning in linear space. For instance, instead of adjusting for a desired overdrive pixel luminance value of 10% greater than the difference between the initial pixel luminance value and the target pixel luminance value, the system(s) may tune for a desired overdrive pixel brightness that is 10% (and or any other percentage or value) greater than the difference between the initial perceived brightness of the pixel and the target perceived brightness of the pixel. In some examples, the system(s) may convert between measured luminance and perceived brightness using a gamma curve and/or another model/function that correlates with human perception. For instance, the system(s) may map measured luminance values indicated in the sensor data to corresponding, perceived brightness values using the gamma curve. Based on this mapping, the system(s) may make predictions and/or refine overdrive voltages during testing/tuning.

As described herein, the system(s) may determine the overdrive voltages and/or other RTC parameters for a plurality of pixel value transitions for the display, and generate one or more data structures to store in memory of the display. For instance, the system(s) may generate one or more overdrive lookup tables using the determined overdrive voltages, and store the overdrive lookup tables in the memory of the display (e.g., as part of the firmware). The overdrive lookup tables may include various associations between initial pixel values, target pixel values, and overdrive voltage levels to apply to the pixels for transitioning between the initial pixel values and the target pixel values. In some examples, the system(s) may generate an overdrive lookup table for each refresh rate that the display is capable of generating images at. In this way, the display(s) may select, in real time, the correct overdrive table to use based on the current (e.g., current frame) refresh rate and/or future (e.g., next frame) refresh rate of the display. Additionally, or alternatively, the system(s) may generate and store overdrive lookup tables for a subset of possible refresh rates (frame times), and then interpolate between different tables to find the overdrive values for the current frame time (e.g., predicted frame time).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs) or vision language models (VLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

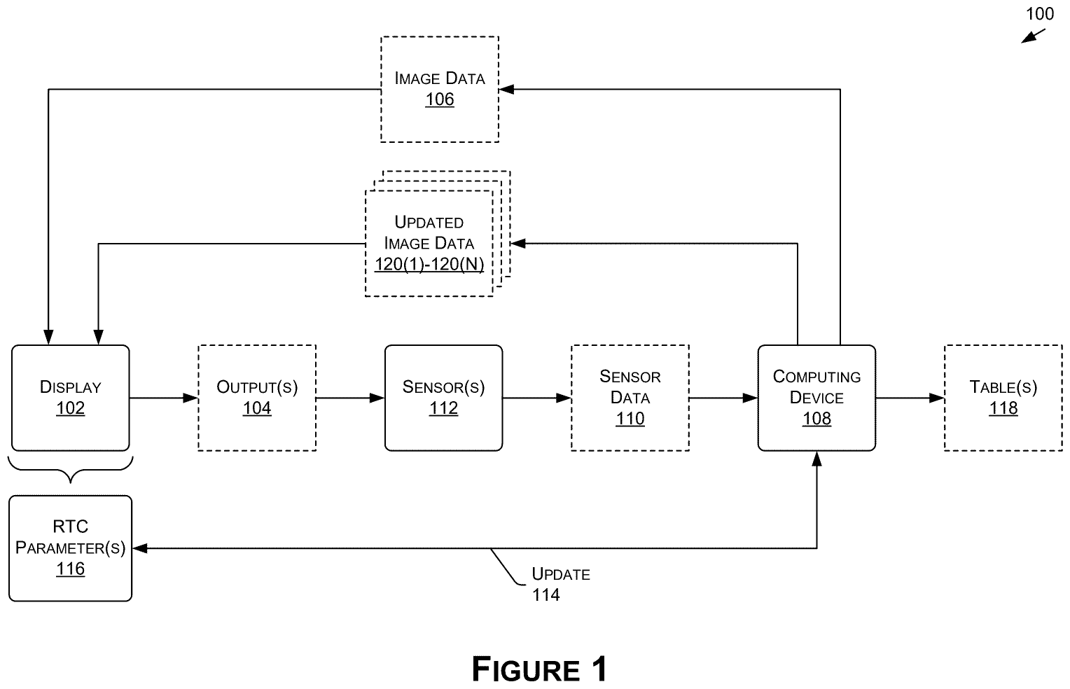

With reference to FIG. 1, FIG. 1 is a data flow diagram illustrating an example process 100 for determining RTC parameters associated with a display, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a display 102 that renders one or more outputs 104 based on image data 106 received from a computing device 108. The computing device 108 may obtain sensor data 110 associated with the output(s) 104 using one or more sensors 112. Based at least on the sensor data 110, the computing device 108 may update 114 one or more RTC parameters 116 associated with the display 102. In some instances, the computing device 108 may perform one or more iterations to refine the RTC parameter(s) 116 and generate one or more tables 118 (e.g., overdrive voltage lookup tables) for the display 102. For instance, the computing device 108 may generate and input one or more instances of updated image data 120(1)-(N) (where “N” represents any number) to the display 102, receive additional sensor data associated with new outputs of the display based on the updated image data 120(1)-(N), and further update 114 the RTC parameter(s) 116.

In some examples, the display 102 may use the image data 106 (and/or the updated image data 120(1)-(N)) to generate the output(s) 104, which may include a series of images. The individual images of the series of images may depict portions of a pattern and/or series of patterns, which may cause pixels of the display 102 to transition between various values. For instance, a first image of the series of images included in the output(s) 104 may correspond to a first portion of the pattern, a second image of the series of images included in the output(s) 104 may correspond to a second portion of the pattern, and so forth. To render the first image, the display 102 may apply a first voltage level to the pixels to set the pixels to one or more initial values. Similarly, to render the second image, the display 102 may transition the pixels from the initial values to one or more target values by applying a second voltage level to the pixels.

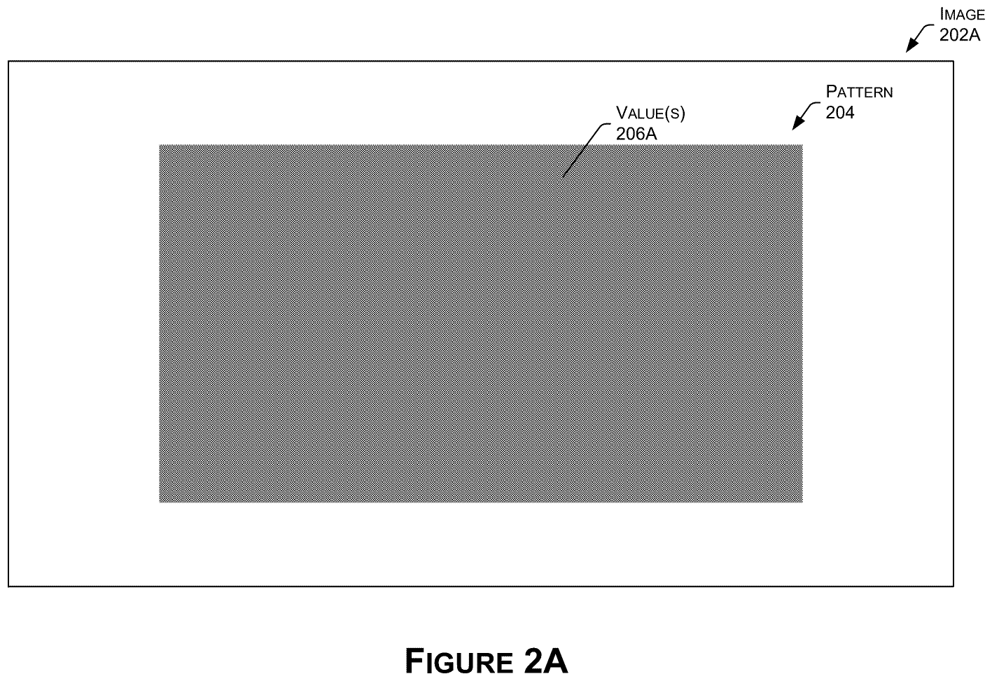

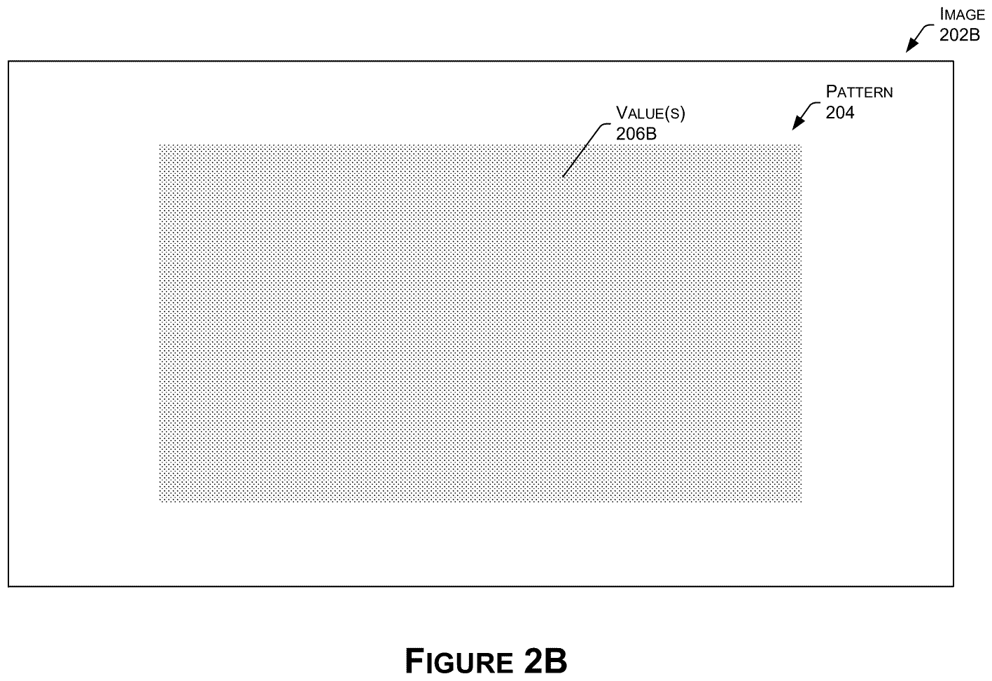

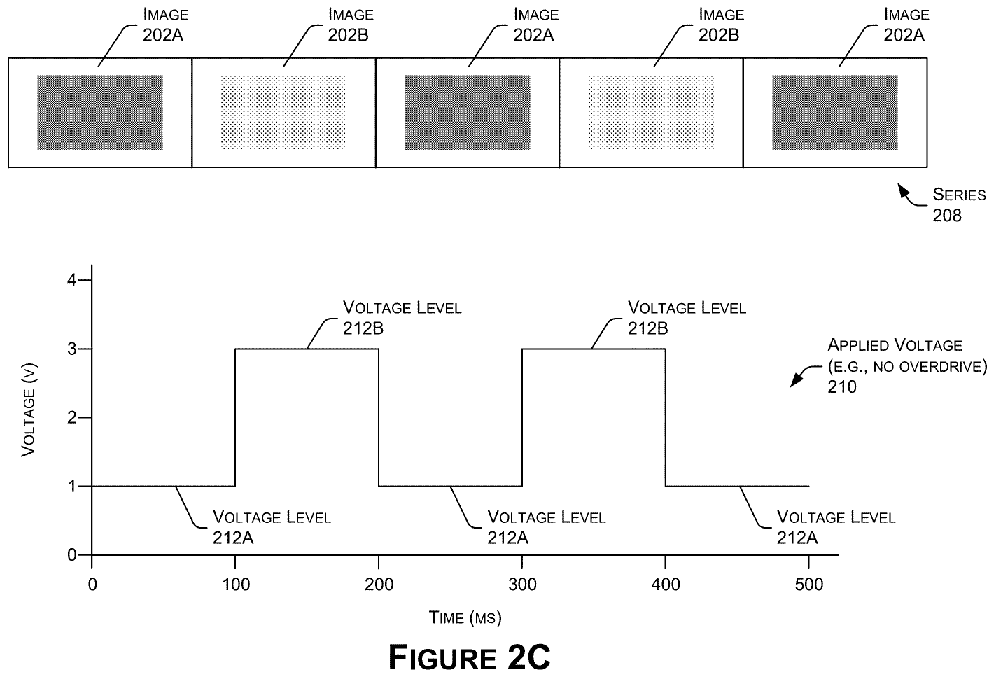

For instance, FIGS. 2A and 2B illustrate example visualizations of images 202 that a system may cause a display to render for determining RTC parameters, in accordance with some embodiments of the present disclosure. Referring first to the example of FIG. 2A, a first image 202A may represent a first portion of a pattern 204. The first portion of the pattern 204 may include one or more first values 206A (which may correspond to the initial values). For instance, the first value(s) 206A of the pattern 204 depicted in the first image 202A may correspond to darker pixels (e.g., lower RGB values). As such, to render the first image 202A, the display 102 may apply a relatively low voltage level to one or more pixels of the display 102 (e.g., those pixels corresponding to the points included in the pattern 204) for a first number of frames. Referring to the example of FIG. 2B, a second image 202B may represent a second portion of the pattern 204. The second portion of the pattern 204 may include one or more second values 206B (which may correspond to the target values). The second value(s) 206B of the pattern 204 depicted in the second image 202B may correspond to brighter pixels (e.g., higher RGB values). To render the second image 202B, the display 102 may apply a higher voltage level (e.g., relative to the first image 202A) to the pixels of the display 102 for a second number of frames.

For instance, FIG. 2C illustrates an example visualization of an applied voltage 210 associated with rendering a series 208 of the images 202A and 202B, in accordance with some embodiments of the present disclosure. For instance, the various levels of the applied voltage 210 may be applied by the display 102 to its individual pixels to render the pattern 204 depicted by the series 208 of the images 202A and 202B. The display 102 may render the series 208 of the images at a 100 Hz refresh rate. As such, the display 102 may render a new frame every 10 milliseconds (ms), and each of the images 202A and 202B may be presented for a total of 10 frames each time the images 202A and 202B appear in the series 208.

As illustrated in the example of FIG. 2C, between 0 and 99 ms (e.g., frames 1-9), the display 102 may apply a first voltage level 212A to the pixels to render the first image 202A for a first time in the series 208. Between 100 and 199 ms (e.g., frames 10-19), the display 102 may apply a second voltage level 212B to the pixels to render the second image 202B for a first time in the series 208. Between 200 and 299 ms (e.g., frames 20-29), the display 102 may apply the first voltage level 212A to the pixels to render the first image 202A for a second time in the series 208. Between 300 and 399 ms (e.g., frames 30-39), the display 102 may once again apply the second voltage level 212B to the pixels to render the second image 202B for a second time in the series 208. Between 400 and 499 ms (e.g., frames 40-49), the display 102 may apply the first voltage level 212A to the pixels to render the first image 202A for a third time in the series 208.

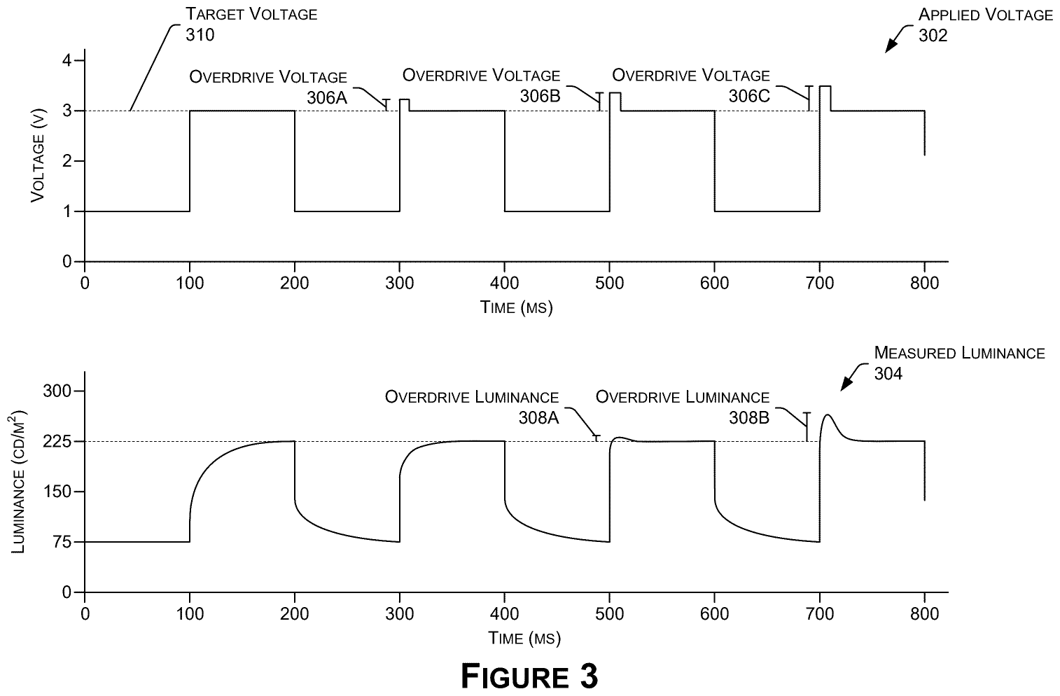

Although not illustrated in the example of FIG. 2C, but as will be discussed in further detail with respect to the example of FIG. 3, during the transition of the pixels from the initial values to the target values between the first image and the second image, the display 102 may apply an overdrive voltage/RBG value to the pixels to accelerate the transition from the initial values to the target values. The overdrive voltage may differ in magnitude from the first voltage level 212A and second voltage level 212B illustrated in FIG. 2C. For instance, in the transition from the first image 202A and the second image 202B where the initial values of the pixels in the first image 202A are less than the target values for the pixels in the second image 202B (e.g., low to high transition), the overdrive voltage may be greater than the second voltage level 212B. In contrast, such as in the transition from the second image 202B to the first image 202A, since the initial values of the pixels in the second image 202B are greater than the target values for the pixels in the first image 202A (e.g., high to low transition), the overdrive voltage may be less than the first voltage level 212A. As described herein, the values of the pixels—such as the initial values, the target values, intermediate values, or any other values—may correspond to colors and/or gray levels of the pixels, RGB values of the pixels, intensities of the pixels, voltage levels applied to the pixels, etc.

In some instances, the computing device 108 may cause the display 102 to render the images of the series of images in the output(s) 104 at one or more frame refresh rates. For example, the computing device 108 may cause the display 102 to render the output(s) 104 at a first refresh rate (e.g., 120 Hz) to determine one or more first overdrive voltages to be applied to the pixels to transition between the initial values and the target values when the display 102 is operating (e.g., rendering frames) at the first refresh rate. Additionally, or alternatively, the computing device 108 may cause the display 102 to render the output(s) 104 at a second refresh rate (e.g., 240 Hz) to determine one or more second overdrive voltages to be applied to the pixels to transition between the initial values and the target values when the display 102 is rendering images at the second refresh rate. For instance, the display 102 may be a variable refresh rate (VRR) display panel that dynamically adjusts the refresh rate to match the frame rate output of the content being rendered by the graphics card or video source, and the VRR display panel may use multiple overdrive tables (e.g., table(s) 118) and/or other RTC parameters for the different refresh rates. While these are just a few examples of how and why the display 102 may render the series of images at varying refresh rates to tune voltage overdrive parameters, in other examples, the display 102 may render any other types of patterns and/or images at any other types of voltage levels and/or at any other update rates.

Referring back to the example of FIG. 1, the process 100 may also include the computing device 108 obtaining sensor data 110 associated with the output(s) 104 of the display 102 while causing the display 102 to render the series of images. In some examples, the sensor(s) 112 used to obtain the sensor data 110 may be mounted to the screen of the display 102. For instance, a surface of the sensor (e.g., a sensing surface) may contact a surface of the screen of the display 102, and the sensor(s) 112 may be affixed to the display 102 via various means (e.g., straps, bands, etc.) or otherwise remain in close physical contact with the display 102 throughout a calibration session. Because the sensor(s) 112 are affixed to the display 102 in this way, the calibration of the display 102 may be performed in virtually any environment. For instance, instead of requiring a dark space for calibrating overdrive, the overdrive may be calibrated in any space regardless of ambient lighting conditions. Additionally, the overdrives may be calibrated using low-cost consumer computers as opposed to expensive lab equipment/computers.

For instance, the computing device 108 may use the sensor(s) 112 to generate the sensor data 110 while the display 102 is rendering the series of images. In some examples, the sensor data 110 may indicate luminance values associated with the pixels of the display 102 during the rendering of the images. Because the sensor data 110 may be obtained while the display 102 is rendering the series of images, the luminance values may be indicative of the actual or measured luminance of the pixels of the display 102 over time during the transition of the pixels from the initial values to the target values. In some instances, the sensor(s) 112 may include, but are not limited to, photodiodes, photometers, spectroradiometers, lux meters (illuminance meters), colorimeters, a combination thereof, and/or any other sensors for measuring the luminance output by a display and/or pixels of a display. As such, the sensor data 110 may include, but is not limited to, photodiode data, photometer data, spectroradiometer data, lux meter data, colorimeter data, a combination thereof, and/or any other sensor data for indicating luminance.

For instance, FIG. 3 illustrates an example visualization of a relationship between luminance of a display panel and voltage applied to the display panel, in accordance with some embodiments of the present disclosure. For instance, the upper graph depicted in the example of FIG. 3 may represent the various levels of applied voltage 302 to pixels of the display to render a series of images, such as the series 208 of the images described in FIG. 2C. The lower graph depicted in the example of FIG. 3 may represent the measured luminance 304 associated with the pixels of the display based on the various levels of the applied voltage 302. As such, the values of the measured luminance 304 may correspond to the values of the applied voltage 302.

Using the sensor data 110, the computing device 108 may determine the measured luminance 304 for the pixels that correspond to various values (e.g., gray level values, RGB values, etc.) of the pixels throughout the series of images. For instance, and for a transition of a pixel from an initial value to a target value (e.g., corresponding to the target voltage 310), the computing device 108 may use the sensor data 110 to determine a first luminance value corresponding to the initial value of the pixel (e.g., between 0 ms and 100 ms), a second luminance value corresponding to the target value of the pixel (e.g., at 199 ms), and a third luminance value corresponding to an overdrive voltage level applied to the pixel during the transition between the initial value and the target value. For instance, the display 102 may apply a first overdrive voltage 306A at 300 ms, a second overdrive voltage 306B at 500 ms, and a third overdrive voltage 306C at 700 ms. Because of this, the measured luminance 304 may include a first overdrive luminance 308A that corresponds to the second overdrive voltage 306B, as well as a second overdrive luminance 308B that corresponds to the third overdrive voltage 306C. In some instances, the overdrive luminance values 308 may be representative of a maximum (e.g., peak) measured luminance 304 between the first and second luminance values. Additionally, the computing device 108 may determine luminance measurements for one or more intermediate points throughout the transition (e.g., at 10% and 90% through the transition, etc.) to determine a response time associated with the transition.

In some examples, the overdrive voltage/RGB value may be applied for a first frame during a transition. For instance, if the refresh rate of the display associated with the example of FIG. 3 is 100 Hz, then 10 frames may be associated with a given image during the pattern of the series of images. As such, the overdrive value may be applied for the first frame of the 10 frames associated with the particular image being displayed, and then the RGB/voltage level may be attenuated back to the target voltage 310 for the remaining 9 frames until the display renders the new image (e.g., for the 1V color image).

Referring back to the example of FIG. 1, in some examples, the computing device 108 may use the various luminance values and the applied voltage levels (which may correspond to pixel RGB value) to determine or otherwise tune the overdrive voltage levels for the display 102. For instance, based on the measured luminance 304 and the applied voltage 302, the computing device 108 may update 114 the RTC parameter(s) 116 to, among other things, refine the overdrive voltage level for the display 102. As a first example, if the initial pixel value is 100 RGB (e.g., 100, 100, 100), the target pixel value is 200 RGB, and the desired overdrive is 10% in perceived brightness, the computing device 108 may iteratively update 114 the RTC parameter(s) 116 (e.g., the overdrive voltage level), cause the display 102 to render the output(s) 104 based on the image data 106 and/or the updated image data 120(1)-(N), and evaluate an overdrive luminance value(s) until an overdrive voltage level is determined that results in the overdrive luminance value(s) having a magnitude(s) that corresponds to 10% greater than the difference in perceived brightness between 100 RGB and 200 RGB.

In some examples, the computing device 108 may optimize this process when determining the overdrive voltage for a pixel value transition by adjusting the overdrive voltage in larger increments initially, and then making smaller adjustments as the overdrive voltage becomes closer to the target overshoot. Continuing the example from above where the initial pixel value is 100 RGB, the target pixel value is 200 RGB, and the desired overdrive is 10% in perceived brightness, in a first iteration, the computing device 108 may initially set the overdrive voltage to 4.46 volts, which could be the standard voltage level applied to the pixel to drive it to 210 RGB. After evaluating the sensor data 110, if the overdrive luminance value corresponds to, for instance, a 2% overshoot in perceived brightness, the computing device 108 may determine to increase the overdrive voltage. In a second iteration, the computing device 108 may update 114 the RTC parameter(s) 116 to increase the overdrive voltage to 4.52 volts—which could be the standard voltage level to output 230 RGB—and then cause the display 102 to render the image(s) again using the updated parameters. After evaluating the sensor data 110 from the second iteration, if the computing device 108 determines the overdrive luminance value corresponds to, for instance, a 14% overshoot in perceived brightness, the computing device 108 may determine to decrease the overdrive voltage, albeit by less of a magnitude than in the second iteration. For instance, in a third iteration, the computing device 108 may decrease the overdrive voltage to 4.50 volts and re-evaluate. This process may repeat, making finer and finer overdrive voltage adjustments, until the computing device 108 determines the desired overdrive voltage for the transition from 100 RGB to 200 RGB for the display 102.

Additionally, in some examples, the computing device 108 may perform similar or the same techniques to determine the overdrive voltages for different refresh rates of the display 102. For instance, the computing device 108 may alter the refresh rate of the display 102 (e.g., by altering the image data 106, by altering parameters of the display 102, etc.) and perform the techniques described herein of evaluating the sensor data 110 associated with the output(s) 104 to refine the voltage overdrive. In various examples, the computing device 108 may perform this process for each refresh rate at which the display 102 is capable of operating.

In some instances, the computing device 108 may determine the overdrive voltages for the display 102 in perceptual space. That is, because the human eye perceives changes in light non-linearly, the computing device 108 may convert linear pixel values and/or luminance values to perceptual brightness values during tuning, which may allow the computing device 108 to tune the overdrive voltages in perceptual space and make the display 102 output higher quality images than just tuning in linear space. For instance, instead of adjusting for a desired overdrive pixel value of 10% greater than the difference between the initial pixel value and the target pixel value, the computing device 108 may tune for a desired overdrive pixel brightness that is 10% (and or any other percentage or value) greater than the difference between the initial perceived brightness of the pixel and the target perceived brightness of the pixel. In some examples, the computing device 108 may convert between measured luminance and perceived brightness using a gamma curve and/or another model/function. For instance, the computing device 108 may map measured luminance values indicated in the sensor data 110 to corresponding, perceived brightness values using the gamma curve. Based on this mapping, the computing device 108 may make predictions and/or refine overdrive voltages during testing/tuning.

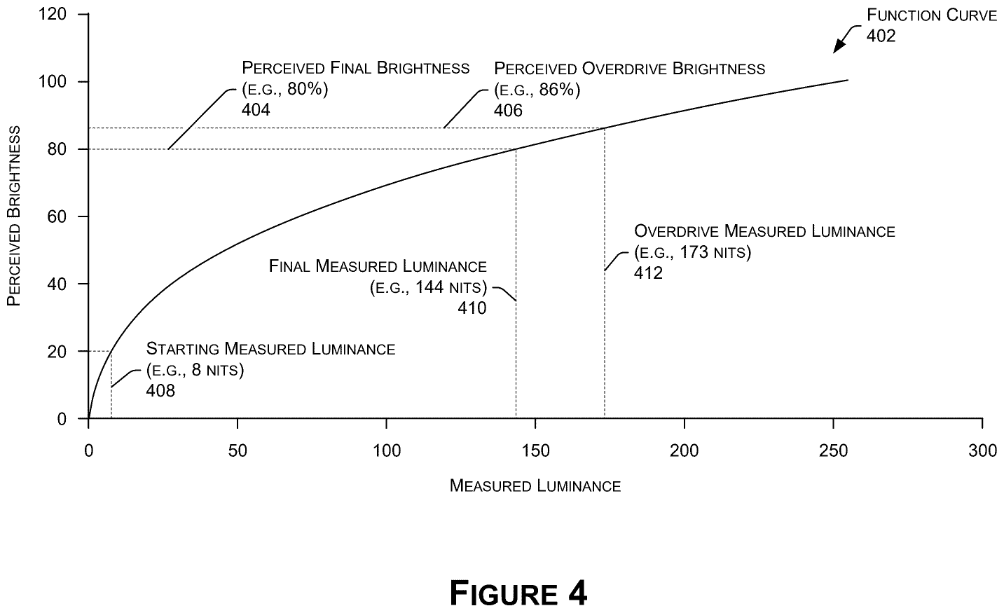

For instance, FIG. 4 illustrates an example function curve 402 that may be used to map luminance values to perceived brightness values, in accordance with some embodiments of the present disclosure. The example of FIG. 4 illustrates example values that may be used when tuning the overdrive voltage to transition between a starting perceived brightness of 20% to a perceived final brightness 404 of 80%, with a 10% perceived overdrive brightness 406. For instance, to tune the overdrive voltage for this transition specification, the system(s) may convert from the perceived brightness values to the measured luminance values. For instance, the system(s) may convert the starting brightness of 20% to the starting measured luminance 408 of 8 nits, convert perceived final brightness of 80% to the final measured luminance 410 of 144 nits, and convert the perceived overdrive brightness 406 of 86% to the overdrive measured luminance 412 of 173 nits. By determining the overdrive voltages in perceptual space by converting measured luminance to perceived brightness, the display 102 may produce more consistent, higher quality images across the entire range of pixel values.

Referring back to the example of FIG. 1, the computing device 108 may generate the tables(s) 118. For instance, the computing device 108 may generate one or more overdrive lookup tables based on determining the overdrive voltages using the process 100, and the computing device 108 may store the overdrive lookup tables in the memory of the display 102 (e.g., as part of the firmware). The overdrive lookup tables may include various associations between initial pixel values, target pixel values, and overdrive voltage/RGB levels to apply to the pixels for transitioning between the initial pixel values and the target pixel values. In some examples, the computing device 108 may generate an overdrive lookup table for each refresh rate that the display 102 is capable of generating images at. In this way, the display 102 may select, in real time, the correct overdrive table to use based on the current (e.g., current frame) refresh rate and/or future (e.g., next frame) refresh rate of the display 102.

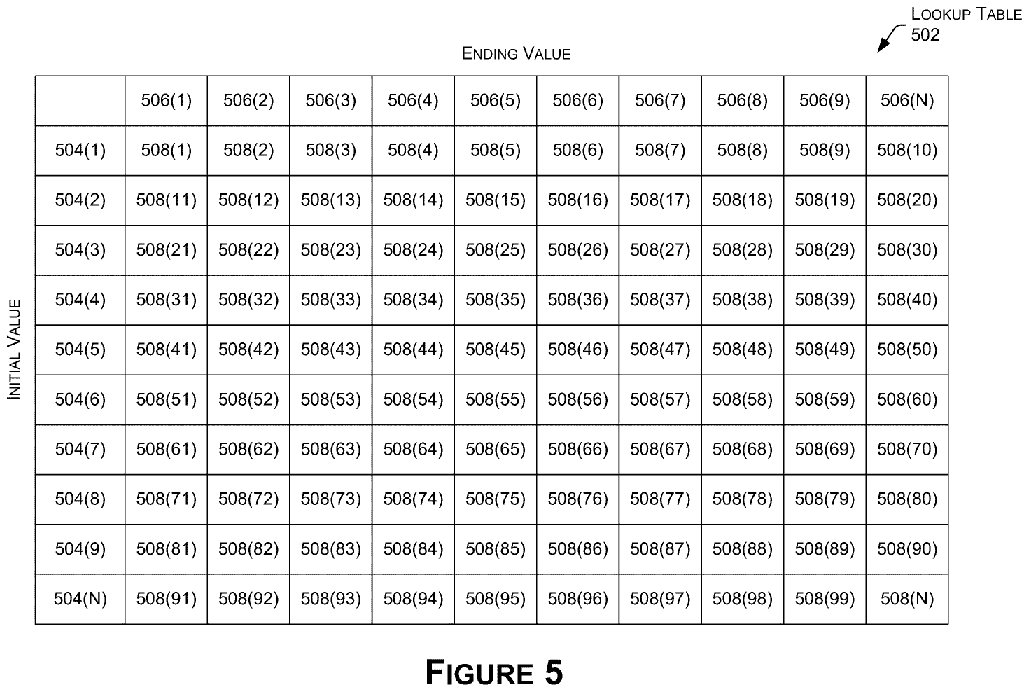

For instance, FIG. 5 illustrates an example lookup table 502 (which may be included in the table(s) 118) that may be generated in accordance with some embodiments of the present disclosure. The lookup table 502 may include a column of initial values 504(1)-504(N) (referred to collectively as “initial values 504”). The lookup table 502 may also include a row of ending values 506(1)-506(N) (referred to collectively as “ending values 506”), which may also be referred to herein as “target values.” The lookup table 502 also includes one or more overdrive values 508(1)-508(N) (referred to collectively as “overdrive values 508”). In various examples, to use the lookup table 502, a display may determine the initial values 504 of one or more pixels, then determine the ending values 506 of the pixel(s), and then determine the overdrive values 508 for the pixel(s). As an example, if the initial value of a pixel corresponds to the initial value 504(7), and the ending value for the pixel corresponds to the ending value 506(3), then the overdrive value 508(63) may be used for the transition. While this is just one example of a lookup table and how a display may use the lookup table, in other examples, any other formats of lookup tables and/or any other types of data structures may be used for a display to determine the overdrive voltage for transitioning a pixel from a first value to a second value.

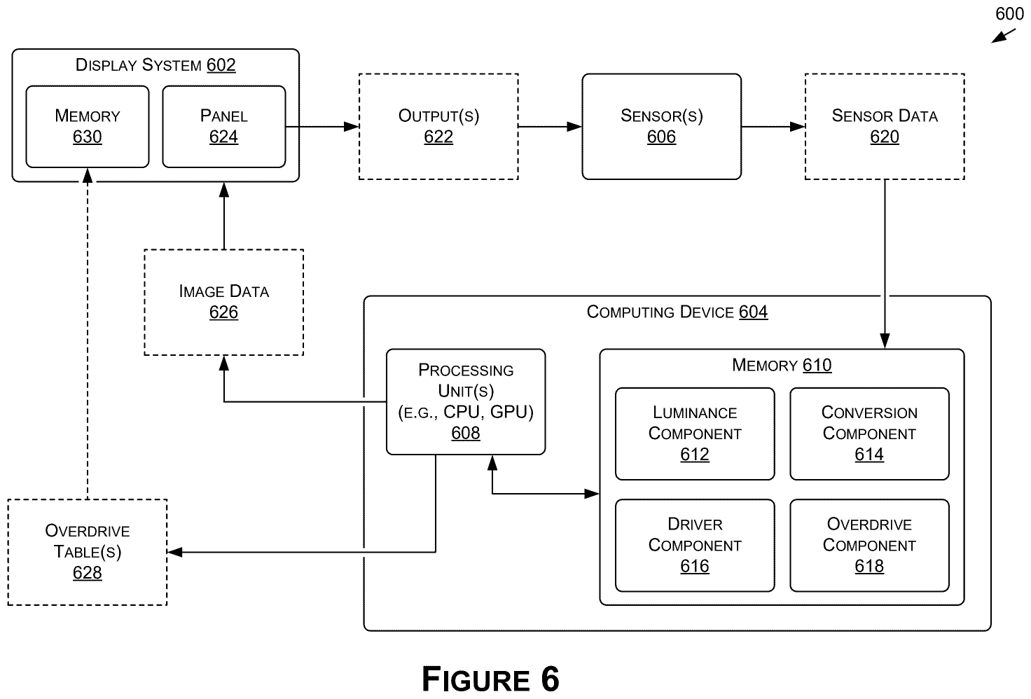

Referring now to FIG. 6, FIG. 6 illustrates an example system 600 that may be used to determine RTC parameters associated with a display system 602, in accordance with some embodiments of the present disclosure. In some examples, the display system 602 may correspond to the display 102 described with respect to the example of FIG. 1. The system 600 may also include a computing device 604 (which may correspond to the computing device 108) and one or more sensors 606 (which may correspond to the sensor(s) 112).

The computing device 604 may include one or more processing units 608 and memory 610, which may be communicatively coupled to one or more of the processing unit(s) 608. The processing unit(s) 608 may include, but are not limited to, central processing units (CPUs), graphics processing units (GPUs), data processing units (DPUs), and/or any other type of specialized or non-specialized processing units. The memory 610 may store various components, including, but not limited to, a luminance component 612, a conversion component 614, a driver component 616, and an overdrive component 618. In various examples, the components stored in the memory 610 may represent computer executable instructions that, when executed by the processing unit(s) 608, cause the processing unit(s) 608 to perform one or more operations described herein.

For instance, the luminance component 612 may process sensor data 620, which may be obtained using the sensor(s) 606. The luminance component 612 may process the sensor data 620 to determine one or more luminance values associated with one or more outputs 622 of the display system 602. That is, the luminance values may correspond to luminance measurements for one or more pixels of a panel 624 of the display system 602 in the output(s) 622. For instance, in a first image of the output(s) 622 a pixel may have a first RGB value and in a second image of the output(s) 622 the pixel may have a second RGB value. Additionally, the luminance component 612 may determine luminance values for one or more points of the output(s), where a point of the point(s) may include one or more pixels.

In some examples, the conversion component 614 may convert measured luminance values to perceived brightness values, and vice versa. For instance, the conversion component 614 may use one or more functions, such as the function curve 402, to convert the measured luminance values indicated in the sensor data 620 to the perceived brightness values. In this way, the overdrive component 618 may determine the overdrive voltage levels relative to perceptual space as a human being would perceive the output of a display, as opposed to determining the overdrive voltage levels relative to linear space (e.g., measured/output luminance space, etc.). That is, the conversion component 614 may convert to perceptual space so the overdrive voltage levels may be tuned such that the output images of the display system 602 are higher quality from the perception of a human being, instead of tuning the overdrive voltages with respect to minor changes in values (e.g., measured luminance the human eye may not actually perceive.

The driver component 616, in some examples, may send image data 626 to one or more GPUs of the processing unit(s) 608, and the GPU(s) may process and/or forward the image data 626 to the display system 602 for rendering as the output(s) 622. The driver component 616 may cause the GPU(s) to drive the panel 624 of the display system 602 at target refresh rates precisely, as well as cause the panel 624 of the display system 602 to render the output(s) 622 following the precise timing. In some examples, the driver component 616 may monitor timestamps of the GPU display hardware to verify the display system 602 is rendering frames at the precise timing. In some instances, if the driver component 616 determines that frames were not rendered at the exact timing requirements, the driver component 616 may perform one or more operations to ensure the sensor data 620 for those frames is not considered in the overdrive calibration. For instance, the sensor data may be flagged, or the driver component 616 may signal to restart the test. Additionally, in some examples, frame renderings and measurements may be repeated if the timestamps are incorrect or otherwise do not correspond to the timing requirements.

The overdrive component 618 may determine one or more overdrive voltages to be applied to a pixel(s) of the display system 602 when transitioning the pixel(s) between a first value(s) and a second value(s). For instance, the overdrive component 618 may determine the overdrive voltage(s) based at least on the sensor data 620 and or other information obtained from the luminance component 612, the conversion component 614, the driver component 616, and/or any other components or data. The overdrive component 618 may determine overdrive voltages for every possible pixel value transition the display system 602 is capable of applying. Additionally, the overdrive component 618 may determine overdrive voltages for every possible refresh rate the display system 602 is capable of operating at.

In some examples, the overdrive component 618 may generate one or more overdrive tables 628, and the computing device 604 may cause the overdrive table(s) 628 to be stored in memory 630 of the display system 602 (e.g., in firmware). The overdrive table(s) 628 may include various associations between initial pixel values, target pixel values, and overdrive pixel values for transitioning between the initial pixel values and the target pixel values. In some examples, the overdrive component 618 may generate an overdrive table for each refresh rate that the display system 602 is capable of generating images at. In this way, the display system 602 may select, in real time, the correct overdrive table to use based on the current (e.g., current frame) refresh rate and/or future (e.g., next frame) refresh rate of the display system 602.

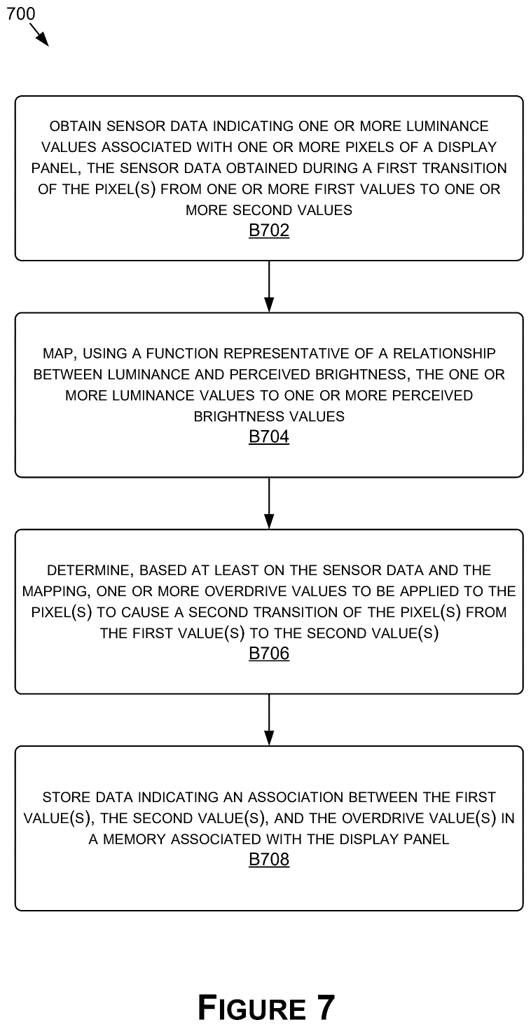

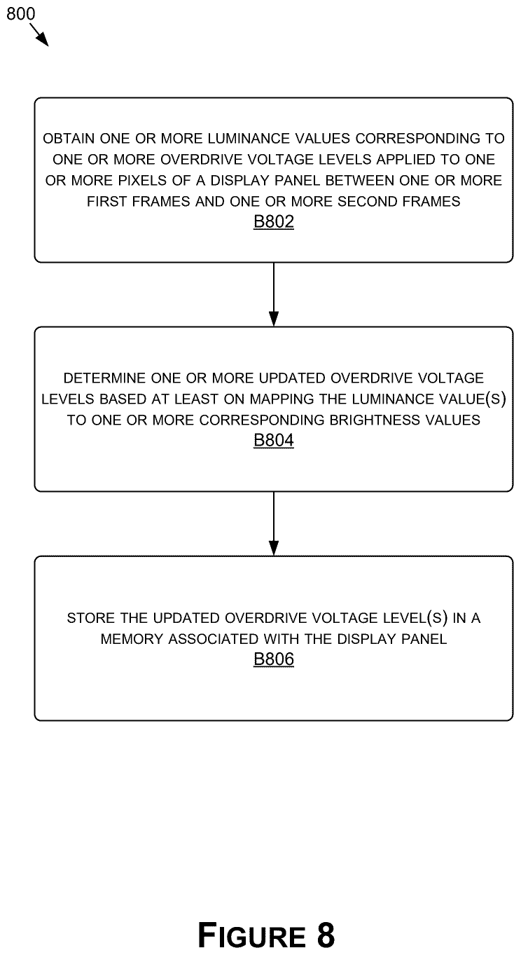

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700 and 800 are described, by way of example, with respect to the system of FIG. 1. However, these methods may additionally or alternatively be executed by any one system, or any combination of systems, including, but not limited to, those described herein.

FIG. 7 is a flow diagram illustrating an example method 700 for tuning overdrive voltage levels for a display panel based on sensor data, in accordance with some embodiments of the present disclosure. The method 700, at block B702, includes obtaining sensor data indicating one or more luminance values associated with one or more pixels of a display panel, the sensor data obtained during a first transition of the one or more pixels from one or more first values to one or more second values. For instance, the computing device 108 may obtain the sensor data 110 from the sensor(s) 112. The sensor data 110 may indicate the luminance value(s) associated with the pixel(s) of the display 102 during the transition of the pixel(s) from the first value(s) to the second value(s).

In some examples, the sensor data may be captured over a period of time in which the display panel is presenting a series of images. The series of images may collectively represent a pattern, and the pattern may have characteristics or attributes that causes the display to transition the pixel(s) from the first value(s) to the second value(s). For instance, a first image of the series of images may depict a first gray level, a second image of the series of images may depict a second gray level that may be different than the first gray level, a third image of the series of images may depict a third gray level that may be different than the second gray level, and so forth.

As another example, the series of images may include just the first image and the second image, and the system(s) may cause the display panel to repeatedly present the first image and the second image while the system(s) modifies an overdrive voltage of the display panel that is applied to the pixel(s) when transitioning from presenting the first image to presenting the second image, and vice versa. For instance, the system(s) may cause the display panel to transition from rendering the first image to rendering the second image using a first overdrive voltage. The system(s) may then cause the display panel to, again, transition from rendering the first image to rendering the second image using a second overdrive voltage. Then, the system(s) may cause the display panel to, yet again, transition from rendering the first image to rendering the second image using a third overdrive voltage, and so forth. During these renderings, the system(s) may obtain the sensor data using the sensor(s) to measure the luminance output by the pixels (e.g., collectively or individually) of the display panel.

The method 700, at block B704, includes mapping, using a function representative of a relationship between luminance and perceived brightness, the one or more luminance values to one or more perceived brightness values. For instance, the computing device 108 may map the luminance value(s) to the perceived brightness value(s). In some instances, the function may correspond to a Gamma function representing the relationship between luminance and perceived brightness. Additionally, or alternatively, any function representing how a human eye perceives color and/or luminance may be used.

The method 700, at block B706, includes determining, based at least on the sensor data, one or more overdrive values to be applied to the pixel(s) to cause a second transition of the pixel(s) from the first value(s) to the second value(s). For instance, the computing device 108 may determine the overdrive value(s) to be applied to the pixel(s) to cause the second transition of the pixel(s) of the display 102 from the first value(s) to the second value(s). That is, based at least on the sensor data, the computing device 108 may determine optimal overdrive voltage levels/RGB values for various transitions of the pixels. For instance, the computing device 108 may determine the optimal overdrive voltage levels/RGB values to transition the pixels (collectively and/or individually) from a first RGB value to a second RGB value, from the first RGB value to a third RGB value, from the second RGB value to the third RGB value, etc. In some instances, the computing device may determine the optimal overdrive voltage levels/RGB values for transitioning the pixels between any possible combination of RGB values the display is capable of applying to the pixels.

In some examples, the system(s) may convert the luminance value(s) indicated in the sensor data to perceptual brightness values using one or more functions. In this way, the system(s) may determine the overdrive voltage levels relative to perceptual space as a human being would perceive the output of a display, as opposed to determining the overdrive voltage levels relative to linear space (e.g., measured/output luminance space, etc.). That is, the system(s) may convert measured luminance to perceptual space so the overdrive voltage levels may be tuned such that the output images of the display are higher quality from the perception of a human being, instead of tuning the overdrive voltages with respect to minor changes in values (e.g., measured luminance, etc.) the human eye may not actually perceive.

The method 700, at block B708, includes storing data indicating an association between the first value(s), the second value(s), and the overdrive value(s) in a memory associated with the display panel. For instance, the computing device 108 may store the data in a memory associated with the display 102. In some examples, the data indicating the association between the first value(s), the second value(s), and the overdrive value(s) may be represented as a table, such as an overdrive lookup table. In this way, the display 102 may evaluate the overdrive lookup table when rendering images in which pixel values need to be transitioned from the first value(s) to the second value(s), or transitioned by more than a threshold. For instance, if the display determines a pixel needs to be transitioned by more than a threshold value (e.g., 10 RGB, 20 RGB, 30 RGB, 40 RGB, 50 RGB, etc.) from one frame to the next frame, the display may evaluate the lookup table to determine the optimal overdrive voltage level to apply. Additionally, the threshold value may vary based on the current refresh rate of the display. For instance, for faster refresh rates the threshold value may be higher than for slower refresh rates.

In some examples, the data indicating the association between the first value(s), the second value(s), and the overdrive voltage level(s) may be stored in one or more memories associated with one or more second displays. For instance, a first display of a first model/type may be used to calibrate the overdrive voltage parameters and generate the overdrive tables, and then these parameters/tables may be stored in memory (e.g., firmware) of one or more other displays of the same model/type.

FIG. 8 is a flow diagram illustrating an example method 800 for tuning overdrive voltage levels for a display panel in perceptual space, in accordance with some embodiments of the present disclosure. The method 800, at block B802, includes obtaining one or more luminance values corresponding to one or more overdrive voltage levels applied to one or more pixels of a display panel between one or more first frames and one or more second frames. For instance, the computing device 108 may obtain the luminance value(s) corresponding to the overdrive voltage level(s) applied to the pixel(s) of the display 102 during a transition from the first frame(s) to the second frame(s).

In some examples, the first frame(s) and the second frame(s) may correspond to a series of images, and the system(s) may cause the display panel to repeatedly present the first frame(s) and the second frame(s) while the system(s) modifies the overdrive voltage level(s) of the display panel that is applied to the pixel(s) when transitioning from presenting the first frame(s) to presenting the second frame(s), and vice versa. For instance, the system(s) may cause the display panel to transition from rendering the first frame(s) to rendering the second frame(s) using a first overdrive voltage. The system(s) may then cause the display panel to, again, transition from rendering the first frame(s) to rendering the second frame(s) using a second overdrive voltage. Them, the system(s) may cause the display panel to, yet again, transition from rendering the first frame(s) to rendering the second frame(s) using a third overdrive voltage, and so forth. During these renderings, the system(s) may obtain sensor data using one or more sensors to measure the luminance output by the pixels (e.g., collectively or individually) of the display panel.

The method 800, at block B804, includes determining one or more updated overdrive voltage levels based at least on mapping the luminance value(s) to one or more corresponding brightness values. For instance, the computing device 108 may determine the updated overdrive voltage level(s) based at least on mapping the luminance value(s) to the corresponding brightness value(s). In some instances, the luminance value(s) may be converted to their corresponding perceptual brightness value(s) using one or more functions (e.g., gamma curve). In this way, the computing device 108 may determine the updated overdrive voltage level(s) relative to perceptual space as a human being would perceive the output of a display, as opposed to determining the overdrive voltage levels relative to linear space (e.g., RGB space, measured/output luminance space, etc.). That is, the system(s) of the present disclosure may convert to perceptual space so the overdrive voltage levels may be updated/determined such that the output images of the display are higher quality from the perception of a human being, instead of tuning the overdrive voltages with respect to minor changes in values (e.g., measured luminance, RGB, etc.) the human eye may not actually perceive.

The method 800, at block B806, includes storing the updated overdrive voltage level(s) in a memory associated with the display panel. For instance, the computing device 108 may store the updated overdrive voltage level(s) in the memory associated with the display 102. In some examples, the overdrive voltage level(s) may be stored in firmware of the display 102. In some examples, the updated overdrive voltage level(s) may be stored in a data structure, such as an overdrive lookup table. In this way, the display 102 may evaluate the overdrive lookup table when rendering images in which pixel values need to be transitioned from the first value(s) to the second value(s), or transitioned by more than a threshold.

### Example Computing Device

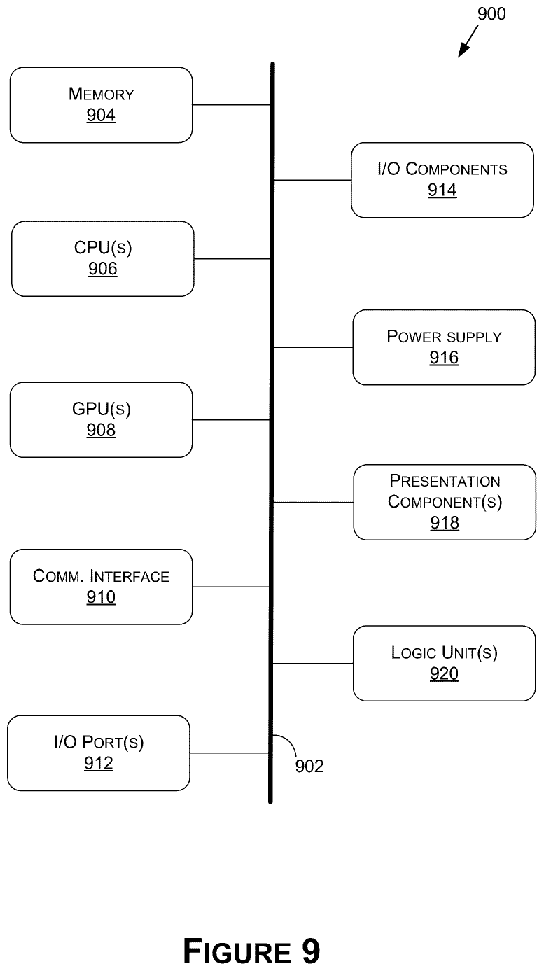

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

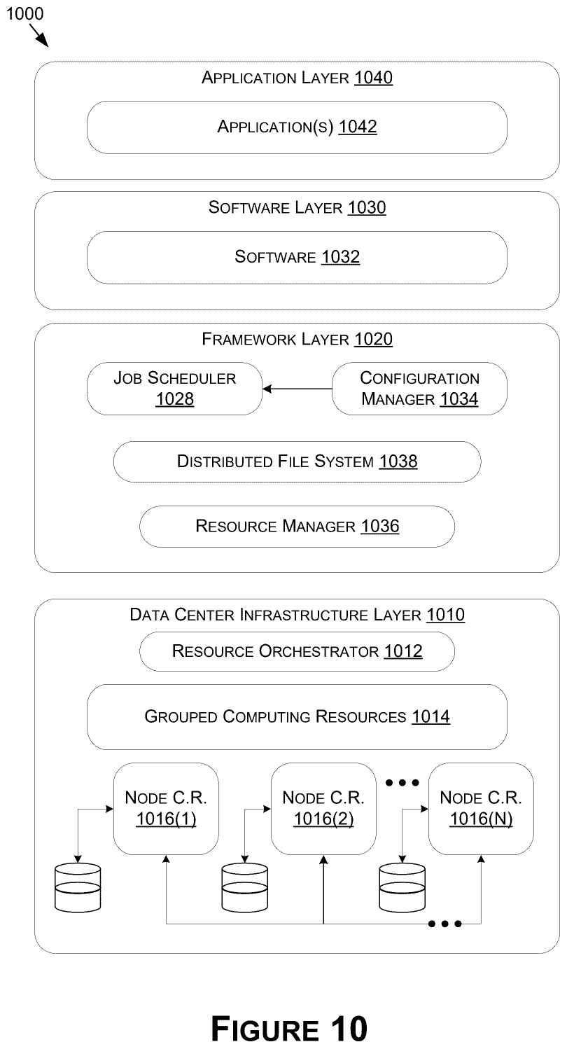

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining sensor data indicating one or more luminance values associated with one or more pixels of a first display panel, the sensor data corresponding to a first transition of the one or more pixels from one or more first values to one or more second values; mapping, using a function representative of a relationship between luminance and perceived brightness, the one or more luminance values to one or more perceived brightness values; determining, based at least on the sensor data and the mapping, one or more overdrive values to be applied to the one or more pixels to cause a second transition of the one or more pixels from the one or more first values to the one or more second values; and storing data indicating an association between the one or more first values, the one or more second values, and the one or more overdrive values in at least one memory associated with one or more second display panels.
B. The method as recited in paragraph A, further comprising determining, using the sensor data, one or more response times associated with a transition of the one or more pixels based at least on one or more second perceived brightness values.
C. The method as recited in any one or paragraphs A-B, wherein the first transition is associated with a first rate and the second transition is associated with a second rate that is different than the first rate based at least on applying the one or more overdrive values to the one or more pixels to cause the second transition.
D. The method as recited in any one or paragraphs A-C, further comprising: causing the first display panel to present a series of images corresponding to a graphical pattern, the series of images including at least a first image and a second image, the first image depicting a first portion of the graphical pattern corresponding to the one or more first values and the second image depicting a second portion of the graphical pattern corresponding to the one or more second values; and obtaining, using one or more sensors detachably coupled to the first display panel, the sensor data while the first display panel is presenting the series of images.
E. The method as recited in any one or paragraphs A-D, further comprising: generating one or more tables indicating the one or more overdrive values to be applied to cause the second transition of the one or more pixels from the one or more first values to the one or more second values; and storing the one or more tables in the memory associated with the one or more second display panels as the data indicating the association between the one or more first values, the one or more second values, and the one or more overdrive values.
F. The method as recited in any one or paragraphs A-E, wherein a first table of the one or more tables corresponds to a first update rate associated with the one or more second display panels and a second table of the one or more tables correspond to a second update rate associated with the one or more second display panels.
G. The method as recited in any one or paragraphs A-F, wherein the one or more overdrive values correspond to one or more Red, Green, Blue (RGB) values indicative of one or more overdrive voltage levels to be applied to the one or more pixels during the second transition.
H. The method as recited in any one or paragraphs A-G, wherein: the one or more first values correspond to at least one of one or more first gray levels associated with the one or more pixels or one or more first voltage levels applied to the one or more pixels prior to the first transition, and the one or more second values correspond to at least one of one or more second gray levels associated with the one or more pixels or one or more second voltage levels applied to the one or more pixels subsequent to the first transition.
I. The method as recited in any one or paragraphs A-H, wherein the one or more overdrive values are determined for one or more first update rates associated with the first display panel, the method further comprising determining, for one or more second update rates associated with the first display panel, one or more second overdrive values to be applied to the one or more pixels to cause a third transition of the one or more pixels from the one or more first values to the one or more second values.
J. The method as recited in any one or paragraphs A-I, further comprising: determining, based at least on one or more intermediate luminance values corresponding to one or more intermediate values of the one or more pixels during the first transition, one or more response times associated with the first transition; and wherein the determining of the one or more overdrive values is further based at least on the one or more response times.
K. A system comprising: one or more processors to: obtain one or more luminance values corresponding to one or more overdrive Red, Green, Blue (RGB) values applied to one or more pixels of a first display panel between one or more first frames and one or more second frames; determine one or more updated overdrive RGB values based at least on mapping the one or more luminance values to one or more corresponding perceived brightness values; and store the one or more updated overdrive RGB values in at least one memory associated with one or more second display panels.
L. The system as recited in paragraph K, the one or more processors further to: cause the display panel to render the one or more first frames and the one or more second frames at one or more refresh rates; obtain one or more timestamps corresponding to the one or more first frames and the one or more second frames; and based at least on the one or more timestamps, determining whether the display panel rendered the one or more first frames and the one or more second frames at the one or more refresh rates prior to the determination of the one or more updated overdrive RGB values.
M. The system as recited in any one or paragraphs K-L, wherein the one or more luminance values are mapped to the one or more corresponding perceived brightness values using a function representative of a relationship between measured luminance and perceived brightness values.
N. The system as recited in any one or paragraphs K-M, wherein the one or more updated overdrive RGB values correspond to one or more voltage levels that are to be applied to one or more liquid crystals within the one or more pixels of the display to transition the one or more liquid crystals from a first orientation to a second orientation at one or more transition rates without exceeding one or more threshold luminance values.
O. The system as recited in any one or paragraphs K-N, wherein the one or more updated overdrive RGB values are determined for one or more first update rates of the display that are distinguishable from one or more second update rates of the display.
P. The system as recited in any one or paragraphs K-O, the one or more processors further to: obtain one or more second luminance values corresponding to one or more target RGB values applied to the one or more pixels to render the one or more second frames; and determine the one or more updated overdrive RGB values based at least on a difference between the one or more luminance values and the one or more second luminance values.
Q. The system as recited in any one or paragraphs K-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
R. At least one processor comprising: processing circuitry to calibrate one or more response time compensation (RTC) parameters associated with a variable refresh rate (VRR) display based at least on sensor data indicating one or more luminance values associated with one or more pixels of the VRR display responsive to applying one or more overdrive values to the one or more pixels during a presentation of a series of images rendered at one or more refresh rates using the VRR display.
S. The processor as recited in paragraph R, wherein the calibration of the one or more RTC parameters associated with the one or more displays is further based at least on mapping the one or more luminance values to one or more perceived brightness values using at least a gamma function curve.
T. The processor as recited in any one or paragraphs R-S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining sensor data indicating one or more luminance values associated with one or more pixels of a first display panel, the sensor data corresponding to a first transition of the one or more pixels from one or more first values to one or more second values;
mapping, using a function representative of a relationship between luminance and perceived brightness, the one or more luminance values to one or more perceived brightness values;
determining, based at least on the sensor data and the mapping, one or more overdrive values to be applied to the one or more pixels to cause a second transition of the one or more pixels from the one or more first values to the one or more second values; and
storing data indicating an association between the one or more first values, the one or more second values, and the one or more overdrive values in at least one memory associated with one or more second display panels.

2. The method of claim 1, further comprising determining, using the sensor data, one or more response times associated with a transition of the one or more pixels based at least on one or more second perceived brightness values.

3. The method of claim 1, wherein the first transition is associated with a first rate and the second transition is associated with a second rate that is different than the first rate based at least on applying the one or more overdrive values to the one or more pixels to cause the second transition.

4. The method of claim 1, further comprising:
causing the first display panel to present a series of images corresponding to a graphical pattern, the series of images including at least a first image and a second image, the first image depicting a first portion of the graphical pattern corresponding to the one or more first values and the second image depicting a second portion of the graphical pattern corresponding to the one or more second values; and
obtaining, using one or more sensors detachably coupled to the first display panel, the sensor data while the first display panel is presenting the series of images.

5. The method of claim 1, further comprising:
generating one or more tables indicating the one or more overdrive values to be applied to cause the second transition of the one or more pixels from the one or more first values to the one or more second values; and
storing the one or more tables in the memory associated with the one or more second display panels as the data indicating the association between the one or more first values, the one or more second values, and the one or more overdrive values.

6. The method of claim 5, wherein a first table of the one or more tables corresponds to a first update rate associated with the one or more second display panels and a second table of the one or more tables correspond to a second update rate associated with the one or more second display panels.

7. The method of claim 1, wherein the one or more overdrive values correspond to one or more Red, Green, Blue (RGB) values indicative of one or more overdrive voltage levels to be applied to the one or more pixels during the second transition.

8. The method of claim 1, wherein:
the one or more first values correspond to at least one of one or more first gray levels associated with the one or more pixels or one or more first voltage levels applied to the one or more pixels prior to the first transition, and
the one or more second values correspond to at least one of one or more second gray levels associated with the one or more pixels or one or more second voltage levels applied to the one or more pixels subsequent to the first transition.

9. The method of claim 1, wherein the one or more overdrive values are determined for one or more first update rates associated with the first display panel, the method further comprising determining, for one or more second update rates associated with the first display panel, one or more second overdrive values to be applied to the one or more pixels to cause a third transition of the one or more pixels from the one or more first values to the one or more second values.

10. The method of claim 1, further comprising:
determining, based at least on one or more intermediate luminance values corresponding to one or more intermediate values of the one or more pixels during the first transition, one or more response times associated with the first transition; and
wherein the determining of the one or more overdrive values is further based at least on the one or more response times.

11. A system comprising:
one or more processors to:
obtain one or more luminance values corresponding to one or more overdrive Red, Green, Blue (RGB) values applied to one or more pixels of a first display panel between one or more first frames and one or more second frames;
determine one or more updated overdrive RGB values based at least on mapping the one or more luminance values to one or more corresponding perceived brightness values; and
store the one or more updated overdrive RGB values in at least one memory associated with one or more second display panels.

12. The system of claim 11, the one or more processors further to:
cause the display panel to render the one or more first frames and the one or more second frames at one or more refresh rates;
obtain one or more timestamps corresponding to the one or more first frames and the one or more second frames; and
based at least on the one or more timestamps, determining whether the display panel rendered the one or more first frames and the one or more second frames at the one or more refresh rates prior to the determination of the one or more updated overdrive RGB values.

13. The system of claim 11, wherein the one or more luminance values are mapped to the one or more corresponding perceived brightness values using a function representative of a relationship between measured luminance and perceived brightness values.

14. The system of claim 11, wherein the one or more updated overdrive RGB values correspond to one or more voltage levels that are to be applied to one or more liquid crystals within the one or more pixels of the display to transition the one or more liquid crystals from a first orientation to a second orientation at one or more transition rates without exceeding one or more threshold luminance values.

15. The system of claim 11, wherein the one or more updated overdrive RGB values are determined for one or more first update rates of the display that are distinguishable from one or more second update rates of the display.

16. The system of claim 11, the one or more processors further to:
obtain one or more second luminance values corresponding to one or more target RGB values applied to the one or more pixels to render the one or more second frames; and
determine the one or more updated overdrive RGB values based at least on a difference between the one or more luminance values and the one or more second luminance values.

17. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. At least one processor comprising:
processing circuitry to calibrate one or more response time compensation (RTC) parameters associated with a variable refresh rate (VRR) display based at least on sensor data indicating one or more luminance values associated with one or more pixels of the VRR display responsive to applying one or more overdrive values to the one or more pixels during a presentation of a series of images rendered at one or more refresh rates using the VRR display.

19. The processor of claim 18, wherein the calibration of the one or more RTC parameters associated with the one or more displays is further based at least on mapping the one or more luminance values to one or more perceived brightness values using at least a gamma function curve.

20. The processor of claim 18, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
